(19) United States
(12) Patent Application Publication
(10) Pub. No.: US 2022/0010106 A1
(43) Pub. Date: Jan. 13, 2022

(54) A COMPOSITION FOR MAKING HYDROPHOBIC ELASTOMERIC ARTICLE

(71) Applicant: Top Glove International Sdn Bhd, Klang (MY)

(72) Inventors: Chong Ban Wong, Klang (MY); Nuriah Binti Mohamad, Klang (MY); Fawiena Amiza Binti Norazmi Sham, Klang (MY)

(73) Assignee: Top Glove International Sdn Bhd, Klang (MY)

(21) Appl. No.: 17/289,571

(22) PCT Filed: Dec. 31, 2019
(86) PCT No.: PCT/MY19/50139

§ 371 Date: Apr. 28, 2021

(30) Foreign Application Priority Data
Apr. 19, 2019 (MY) PI 2019002226

(51) Int. Cl. C08L 9/04; C08K 3/04; A41D 31/10; A41D 19/00

(52) U.S. Cl. CPC C08L 9/04; A41D 19/0055; A41D 31/10; C08K 3/04

(57) ABSTRACT

The present invention relates to a composition for making a hydrophobic elastomeric article comprising a liquid polymer; 0.01 to 1.5 phr of carbon black; and 1 to 15 phr of hydrophobic dispersion comprises activated charcoal, a dispersing agent and a stabilizer.

### FIELD OF INVENTION

The present invention relates to a composition for making an elastomeric article, and particularly to an elastomeric article having hydrophobic surfaces.

### BACKGROUND OF THE INVENTION

Elastomeric articles such as glove are used in various industries including manufacturing plants, chemical laboratories, warehouses and surgical procedures. During use, the glove surface often comes into contact with fluid, thereby contaminating the surface of the glove with contaminants such as dust, dirt and bacteria. Moreover, the adhesion of fluid on the glove surface also reduces the gripping properties of the glove. Consequently, the user is required to remove the gloves covered with fluid and substitute them with another pair to further perform their task. Therefore, there is a need in the art to provide a composition that is capable to produce an elastomeric article that has fluid repellent properties.

Publication US20060251839A1 discloses application of a fluid repellent coating composition to the surface of the elastomeric article, wherein the coating composition comprises a low surface energy ingredient and a hydrophobic ingredient. In one embodiment, the low surface energy ingredient comprises a water-based fluoropolymer or fluorinated polymer, such as a fluoroalkyl acrylic polymer, and the hydrophobic ingredient comprises a water-based wax, which can be an emulsion or dispersion.

Publication US20170204279A1 reveals a stretchable hydrophobic article produced via a process comprising the step of applying a stretchable and hydrophobic coating to article, wherein the hydrophobic coating comprises hydrophobic particle selected from silica or polytetrafluoroethylene.

Nevertheless, the elastomeric article coated with hydrophobic material has the tendency of losing its ability to repel liquid after several times of stretches and abrasions. As a result, there is a current need for an elastomeric article such as glove that can overcome the drawbacks aforementioned.

### SUMMARY OF INVENTION

The main aspect of the present invention is to provide a composition for making a hydrophobic elastomeric article that exhibits good fluid repellent properties. In one embodiment, the surface of the elastomeric article made from the composition of the present invention is able to achieve a fluid contact angle of about 85-95°.

Another aspect of the present invention is to provide a composition capable of producing a hydrophobic elastomeric article that has long lasting hydrophobic effects despite numerous times of stretches and abrasions.

At least one of the preceding objects is met, in whole or in part, by the present invention, in which one of the embodiments of the present invention is a composition for making a hydrophobic elastomeric article comprising a liquid polymer; 0.01 to 1.5 phr of carbon black; and 1 to 15 phr of hydrophobic dispersion comprises activated charcoal, a dispersing agent and a stabilizer.

According to a preferred embodiment, the dispersing agent is selected from sodium salt of polyacrylic acid, maleic acid-acrylic copolymer or salt derivative thereof or sodium salt of naphthalene sulfonic acid.

In another preferred embodiment, the stabilizer is selected from polyethylene glycol, dipropylene glycol, propylene glycol or a combination thereof.

Preferably, the liquid polymer is natural or synthetic latex. More preferably, the liquid polymer is nitrile latex. Alternatively, other polymers including but not limited to polyisoprene, polychloroprene, polyurethane or combination thereof, may also be used to form the elastomeric article.

In yet another preferred embodiment, the hydrophobic dispersion aforementioned further comprising a thickening agent. Preferably, the thickening agent is selected from china clay, acrylic copolymer and polysaccharide or its derivatives. More preferably, the polysaccharide is cellulose.

Advantageously, at least 50% of the activated charcoal in the hydrophobic dispersion has a particle size of less than or equal to 10 μm.

It is preferable that the composition aforementioned further comprising vulcanizing accelerator; vulcanizing activator; crosslinking agent; pH adjuster; wax emulsion; latex stabilizer; and antifoaming agent.

In one embodiment, the elastomeric article made from the composition aforementioned includes but not limited to a glove, condom or finger cot.

The present preferred embodiment of the invention consists of novel features and a combination of parts hereinafter fully described and illustrated in the accompanying drawings and particularly pointed out in the appended claims; it is being understood that various changes in the details may be effected by those skilled in the arts but without departing from the scope of the invention or sacrificing any of the advantages of the present invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is an image comparing fluid contact angle on the surface of a first glove (left) made of composition comprising carbon black, and a second glove (right) made of composition comprising the carbon black and activated charcoal.

FIG. 2 is a photograph comparing condition of the first glove (left) and second glove (right) after being covered with water.

FIG. 3 is a photograph comparing condition of the first wet glove (left) and second wet glove (right) after being dried for several minutes.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention relates to a composition for making a hydrophobic elastomeric article comprising a liquid polymer; 0.01 to 1.5 phr of carbon black; and 1 to 15 phr of hydrophobic dispersion comprises activated charcoal, a dispersing agent and a stabilizer.

It is preferable that the carbon black is derived from heavy petroleum product. The carbon black is used as black pigment in the production of the hydrophobic elastomeric article. Apart from providing colour, the carbon black also functions to alter tensile properties, hydrophobicity and resiliency of the elastomeric article.

The liquid polymer used in the present invention is preferably a natural or synthetic latex. More preferably, nitrile latex is used as the liquid polymer for making the elastomeric article of the present invention. In one embodiment, about 100 phr of nitrile latex is included in the composition to produce the elastomeric article. Although the nitrile latex is preferred in the present invention, other polymers including but not limited to polyisoprene, polychloroprene, polyurethane or combination thereof, may also be used to form the elastomeric article.

Pursuant to the preferred embodiment, the hydrophobic dispersion comprising the activated charcoal, dispersing agent and stabilizer is incorporated in the elastomeric article composition in an amount of about 1-15 phr. In a preferred embodiment, the amount of the activated charcoal present is about 20-40 wt % of the total weight of the hydrophobic dispersion. It is advantageous that at least 50% of the activated charcoal in the hydrophobic dispersion has a particle size of less than or equal to 10 μm. More advantageously, the particle size is between about 3-10 μm.

According to a preferred embodiment, the dispersing agent is selected from sodium salt of polyacrylic acid, maleic acid-acrylic copolymer or salt derivative thereof or sodium salt of naphthalene sulfonic acid. It is preferable that the amount of the dispersing agent present is about 0.01-15 wt % of the total weight of the hydrophobic dispersion.

In accordance with another preferred embodiment, the amount of the stabilizer present is about 0.01-15 wt % of the total weight of the hydrophobic dispersion. The stabilizer is preferably selected from polyethylene glycol, dipropylene glycol, propylene glycol or a combination thereof.

In yet another preferred embodiment, the hydrophobic dispersion further comprising a thickening agent, wherein the thickening agent is selected from china clay, acrylic copolymer and polysaccharide or its derivatives. More preferably, the polysaccharide is cellulose. Advantageously, an amount of 0.01-5 wt % of the thickening agent is added into the hydrophobic dispersion.

The elastomeric article composition aforementioned preferably further comprising vulcanizing accelerator; vulcanizing activator; crosslinking agent; pH adjuster; latex stabilizer; and antifoaming agent. To further enhance the hydrophobicity of the elastomeric article, wax emulsion may be included in the composition in an amount of 0.01-3 phr.

This disclosure also provides a method of producing the hydrophobic elastomeric article using the composition aforementioned, in which the method comprising the steps of mixing the activated charcoal with the dispersing agent and stabilizer to form the hydrophobic dispersion; grinding the activated charcoal in the hydrophobic dispersion to reduce particle size thereof, wherein at least 50% of the activated charcoal in the hydrophobic dispersion has a particle size of less than or equal to 10 μm; and further mixing the hydrophobic dispersion with the carbon black and liquid polymer to form the elastomeric article.

As described above, the composition of the present invention is suitable for making stretchable and hydrophobic elastomeric article including but not limited to glove, condom or finger cot. In one embodiment, glove made from the composition aforementioned exhibits desirable fluid repellent properties, such that a fluid contact angle of about 85-95° is achieved on the surface thereof. Further, the elastomeric article such as the glove is able to retain its hydrophobicity despite multiple times of use and stretches.

### EXAMPLES

The present invention can be further understood through consideration of the following non-limiting Example.

### Example 1

Formulation for the hydrophobic dispersion is shown in TABLE 1 below:

TABLE 1

| Material | Preferred Range |
|---|---|
| Deionized Water | — |
| pH Adjuster | 0.01 to 5 wt % |
| Dispersing Agent | 0.01 to 15 wt % |
| Stabilizer | 0.01 to 15 wt % |
| Thickening Agent | 0.01 to 5 wt % |
| Activated Charcoal Powder | 20 to 40 wt % |

### Example 2

Preparation of the Hydrophobic Dispersion

The hydrophobic dispersion is prepared according to the formulation provided in Table 1. The activated charcoal powder is mixed and homogenized in the formulation aforementioned for 1 hour. The hydrophobic dispersion comprising the activated charcoal is then subjected to horizontal bead grinding to reduce particle size in order to achieve D50 of less than or equal to 10 μm.

### Example 3

The hydrophobic dispersion comprising the activated charcoal, dispersing agent and stabilizer is being ensured to comply the specification as shown in TABLE 2:

TABLE 2

| Aspects | Specification |
|---|---|
| TSC (%) | 20 to 40 |
| pH | 9 to 11 |
| Particle size, D50 (μm) | Less than 10 |

### Example 4

To achieve desired hydrophobic properties, the formulation for the compounded latex is shown in TABLE 3:

TABLE 3

| Material | Preferred Range (phr) |
|---|---|
| Nitrile Latex | 100 |
| pH Adjuster | 0.01 to 5 |
| Vulcanizing Accelerator | 0.01 to 5 |
| Vulcanizing Activator | 0.01 to 5 |
| Crosslinking Agent | 0.01 to 5 |
| Latex Stabilizer | 0.01 to 5 |
| Wax Emulsion | 0.01 to 3 |
| Antifoaming Agent | 0.01 to 1 |
| Hydrophobic Dispersion | 1 to 15 |
| Carbon Black/Black Pigment | 0.01 to 1.5 |

### Example 5

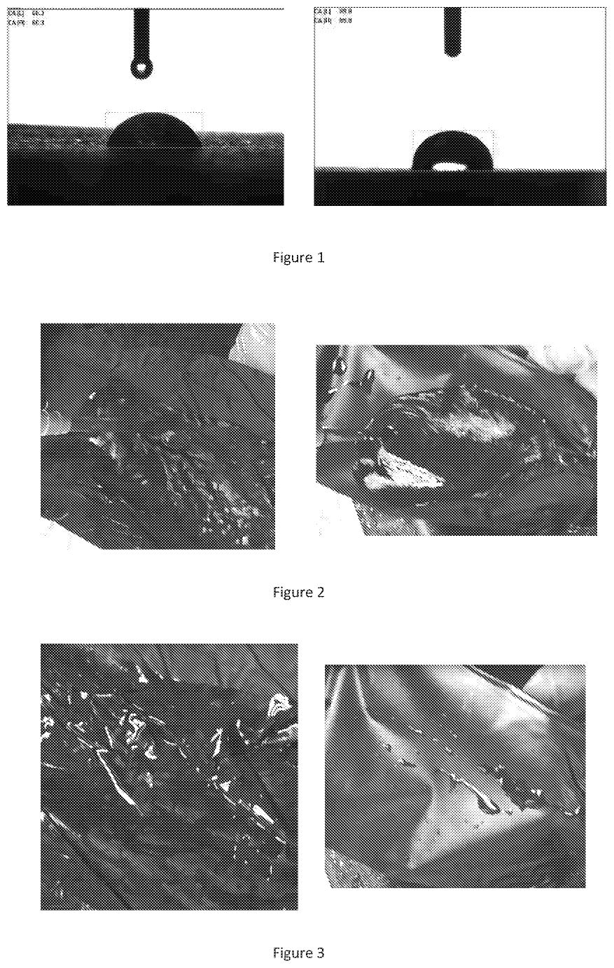

A first glove made of composition comprising carbon black and a second glove made of composition shown in TABLE 3 are prepared and compared for their hydrophobicity features. As shown in FIG. 1, the hydrophobicity measured by fluid contact angle of the second glove (right) is higher as compared to the first glove. It was observed that the surface of the second glove exhibited a fluid contact angle of 89° while the surface of the first glove exhibited a lower fluid contact angle of about 68.3°.

Although the invention has been described and illustrated in detail, it is to be understood that the same is by the way of illustration and example, and is not to be taken by way of limitation. The scope of the present invention is to be limited only by the terms of the appended claims.

1.-9. (canceled)

10. A composition for making a hydrophobic elastomeric article comprising:
a liquid polymer;
0.01 to 1.5 phr of carbon black;
1 to 15 phr of a hydrophobic dispersion that includes activated charcoal, wherein the activated charcoal is present in an amount ranging from 20 to 40 wt % of a total weight of the hydrophobic dispersion;
a dispersing agent; and
a stabilizer.

11. The composition according to claim 10, wherein the dispersing agent is selected from the group consisting of sodium salts of polyacrylic acid, maleic acid-acrylic copolymers or salt derivatives thereof, sodium salts of naphthalene sulfonic acid, and combinations thereof.

12. The composition according to claim 10, wherein the stabilizer is selected from the group consisting of polyethylene glycol, dipropylene glycol, propylene glycol, and combinations thereof.

13. The composition according to claim 10, wherein the liquid polymer is selected from the group consisting of natural rubber latex, nitrile latex, polyisoprene, polychloroprene, polyurethane, and combination thereof.

14. The composition according to claim 10, wherein the hydrophobic dispersion further comprises a thickening agent, wherein the thickening agent is selected from the group consisting of china clay, acrylic copolymers, polysaccharides or their derivatives, and combination thereof.

15. The composition according to claim 10, wherein at least 50% of the activated charcoal in the hydrophobic dispersion has a particle size of less than or equal to 10 μm.

16. The composition according to claim 10, further comprising:
a vulcanizing accelerator;
a vulcanizing activator;
a crosslinking agent;
a pH adjuster;
a wax emulsion;
a latex stabilizer; and
an antifoaming agent.

17. An elastomeric article made from the composition according to claim 10, wherein the elastomeric article is a glove, condom or finger cot.

18. The elastomeric article according to claim 17, wherein the glove exhibits a fluid repellent property such that a fluid contact angle of 85-95° is achieved on a surface thereof.
